(19) United States
(12) Patent Application Publication
(10) Pub. No.: US 2025/0318607 A1
(43) Pub. Date: Oct. 16, 2025

(54) FASTENER STRINGER AND METHOD OF PRODUCING THE SAME

(71) Applicant: YKK CORPORATION, Chiyoda-ku, Tokyo (JP)

(72) Inventors: Mineto TERADA, Kurobe-shi, Toyama (JP); Masanori KAYAHARA, Kurobe-shi, Toyama (JP); Hiromasa ABE, Kurobe-shi, Toyama (JP); Yohei KOYAMA, Kurobe-shi, Toyama (JP); Takayuki MATSUI, Kurobe-shi, Toyama (JP)

(21) Appl. No.: 18/865,626

(22) PCT Filed: May 27, 2022
(86) PCT No.: PCT/JP2022/021799

§ 371 Date: Nov. 13, 2024

(51) Int. Cl. A44B 19/32; A44B 19/26; A44B 19/34; B29C 48/00; B29C 48/08; B29L 5/00

(52) U.S. Cl. CPC A44B 19/32; A44B 19/265; A44B 19/34; B29C 48/0021; B29C 48/08; B29L 2005/00

(57) ABSTRACT

Fastener stringer includes: a fastener tape; a fastener element arranged on a side edge portion of the fastener tape; and a covering member made of soft material and covering the fastener tape, the covering member comprising a sealing portion positioned on an opposite side of the fastener element with respect to the fastener tape in a thickness direction of the fastener tape. The covering member includes a flexible core sheet extending in a longitudinal direction of the fastener stringer. The core sheet is embedded in the soft material such that one surface of the core sheet is at least partially exposed or both surfaces of the core sheet are not exposed.

### TECHNICAL FIELD

The present disclosure relates to fastener stringer and method of producing the same.

### BACKGROUND ART

Less expensive slide fasteners with a limited capability of water repellency and expensive slide fasteners with a sufficient capability of water-tightness or airtightness are known. As one of the former examples, known is a slide fastener having a fastener tape onto which a polyurethane film is laminated. As one of the latter examples, known is a slide fastener including left and right fastener tapes with opposing side edges which abut against each other as injection-molded elements on the left and right sides are engaged.

PTL1 discloses that a fastener element is sewn to a tape portion in which a cover layer of elastic material such as synthetic resin or rubber is adhered to a base fabric, and a thinner portion is formed at the cover layer along the line where the fastener element is sewn (See FIG. 1 of PTL1). PTL2 discloses that coil-like monofilament is sewn to a water-tight or air-tight strip (See FIG. 1 of PTL2).

PTL3 discloses that films (see symbols 21,22 in FIG. 1 of PTL3) are laminated onto fastener tapes (see symbols 11,12 in FIG. 1 of PTL3), and the films are brought into abutting condition with each other as depicted in FIG. 1 of PTL3. PTL4 discloses in its FIG. 15 that sealing portions (see symbol 13 in FIG. 15 of PTL4) are formed at waterproof seal layers (see symbol 4 in FIG. 15 of PTL4). PTL5 discloses in its FIG. 4 that a folded side edge (see symbol 7 in FIG. 4 of PTL5) is arranged to protrude from an engagement center line (see symbol 8 in FIG. 4 of PTL4).

PTL6 discloses a slide fastener in which supporting tapes are respectively covered by cover layers made of synthetic rubber or the like, and opposing edges of the cover layers have intimate contact regions as depicted in FIG. 1 of PTL6 when fastener elements are engaged.

### CITATION LIST

### Patent Literature

[PTL 1] JP Utility-model Application Laid-open No. 4-10711

[PTL 2] JP Patent Application Laid-open No. 63-41561

[PTL 3] CN Examined Utility Model Laid-open No. 212650520

[PTL 4] JP Patent Application Laid-open No. 60-246704

[PTL 5] JP Examined Patent Application Laid-open No. 63-14963

[PTL 6] JP Patent Application Laid-open No. 2000-354505

[PTL 7] JP Patent Application Laid-open No. 2002-45213

[PTL 8] U.S. Pat. No. 8,756,768 Specification

### SUMMARY

### Technical Problem

As discussed at the beginning, less expensive slide fasteners with a limited capability of water repellency are known, and expensive slide fasteners with sufficient capability of water-tightness or airtightness are known; however, intermediate slide fasteners ranked between them have not been supplied in the market so far. In view of such background, the present inventors have discovered a new challenge to provide a slide fastener with a new structure that accommodates lower-cost mass production and has a sufficient level of water-tightness or air-tightness.

### Solution to Problem

Fastener stringer according to one aspect of the present disclosure may include: a fastener tape; a fastener element arranged on a side edge portion of the fastener tape; and a covering member made of soft material and covering the fastener tape, the covering member comprising a sealing portion positioned on an opposite side of the fastener element with respect to the fastener tape in a thickness direction of the fastener tape. The covering member includes a flexible core sheet extending in a longitudinal direction of the fastener stringer, the core sheet is embedded in the soft material such that one surface of the core sheet is at least partially exposed or both surfaces of the core sheet are not exposed.

In some embodiments, the covering member is configured as a supporting substrate that supports the fastener tape.

In some embodiments, one end of the core sheet in a width direction of the fastener stringer is embedded in the sealing portion. One end of the core sheet in the width direction of the fastener stringer may be positioned away from a sealing face of the sealing portion within an extent above the fastener element, and a soft portion may be formed between the one end of the core sheet and the sealing face in the width direction of the covering member. A distance between the one end of the core sheet and the sealing face in the width direction of the covering member may be 1 cm or less.

In some embodiments, the core sheet is a woven sheet, a knitted sheet, a mixed sheet of woven and knitted structures, a paper sheet, a nonwoven fabric or a metal foil.

In some embodiments, the sealing portion is displaceable away from and closer to the fastener tape.

In some embodiments, the covering member is wider than the fastener tape. The covering member may include an attachment portion, the attachment portion being positioned farther from the sealing portion than the fastener tape in a width direction of the fastener stringer and having an exposed surface exposed as not being covered by the fastener tape.

In some embodiments, the sealing portion is shaped to include a slanting portion that is obliquely angled or a wall that stands upright.

In some embodiments, the fastener element is a coiled element sewn to the fastener tape by an attachment thread. The fastener tape may have a main surface at least partially covered by the covering member, and stitches of the attachment thread may be covered by the covering member on the main surface.

Method of manufacturing a fastener stringer according to another aspect of the present disclosure may include: performing extrusion molding to form a covering member in which a flexible core sheet is embedded in soft material such that one surface of the core sheet is at least partially exposed or both surfaces of the core sheet are not exposed; and laminating the covering member onto a fastener tape so as to support the fastener tape by the covering member, the fastener tape having a side edge portion on which a fastener element is arranged.

In some embodiments, the covering member may be laminated onto the fastener tape so as to have a sealing portion positioned on an opposite side of the fastener element with respect to the fastener tape.

In some embodiments, the covering member is laminated onto the fastener tape such that the sealing portion is displaceable away from and closer to the fastener tape.

In some embodiments, extrusion of the covering member by an extruder and lamination of the covering member onto the fastener tape are successively performed without cutting the covering member at a position between the extruder and a location where the lamination is performed.

### Advantageous Effects of Invention

According to an aspect of the present disclosure, there is provided a slide fastener with a new structure that accommodates lower-cost mass production and has a sufficient level of water-tightness or air-tightness.

### BRIEF DESCRIPTION OF DRAWINGS

FIG. 1 is a top view of a slide fastener according to an embodiment of the present disclosure.

FIG. 2 is a partial bottom view of the slide fastener.

FIG. 3 is a partial enlarged view of engaged fastener elements.

FIG. 4 is a schematic partial cross-sectional view of the slide fastener, depicting a state where left and right seal portions abut against each other as left and right fastener elements are engaged.

FIG. 5 is a schematic partial cross-sectional view of the slide fastener, mainly depicting attachment portions outwardly arranged in a width direction of the slide fastener.

FIG. 6 is a schematic partial cross-sectional view of the slide fastener, depicting a state in which the seal portions of cover members deform inside slider.

FIG. 7 is a schematic flowchart of steps for production of a fastener stringer according to one aspect of the present disclosure.

FIG. 8 is a schematic illustration of a non-limiting exemplary extruder.

FIG. 9 is an elevational illustration of a non-limiting exemplary extrusion die

FIG. 10 is a schematic view related to a process of production of the fastener stringer.

FIG. 11 is a schematic view related to a process of production of the fastener stringer.

FIG. 12 is a schematic view related to a process of production of the slide fastener.

FIG. 13 is a schematic partial cross-sectional view of a slide fastener of another example.

FIG. 14 is a schematic illustration of variation of the cover member.

FIG. 15 is a schematic illustration of variation of the cover member.

FIG. 16 is a schematic illustration of variation of the cover member.

FIG. 17 is a schematic illustration of variation of the cover member.

FIG. 18 is a schematic illustration of variation of the cover member.

### DESCRIPTION OF EMBODIMENTS

Hereinafter, various embodiments and features would be discussed with reference to drawings. A skilled person would be able to combine respective embodiments and/or respective features without requiring excess descriptions, and would appreciate synergistic effects of such combinations.

Overlapping descriptions among the embodiments would be basically omitted. Referenced drawings aim mainly for describing inventions and are simplified for the sake of convenience of preparation of drawings. The respective features should be appreciated as universal features not only effective to presently presented slide fasteners and method of producing the same but also effective to other various slide fasteners and method of producing the same not presented in the present specification.

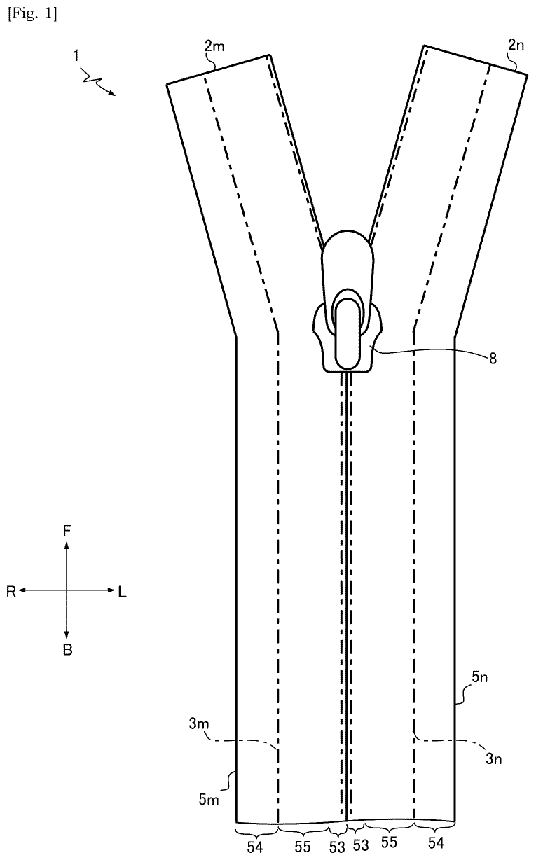

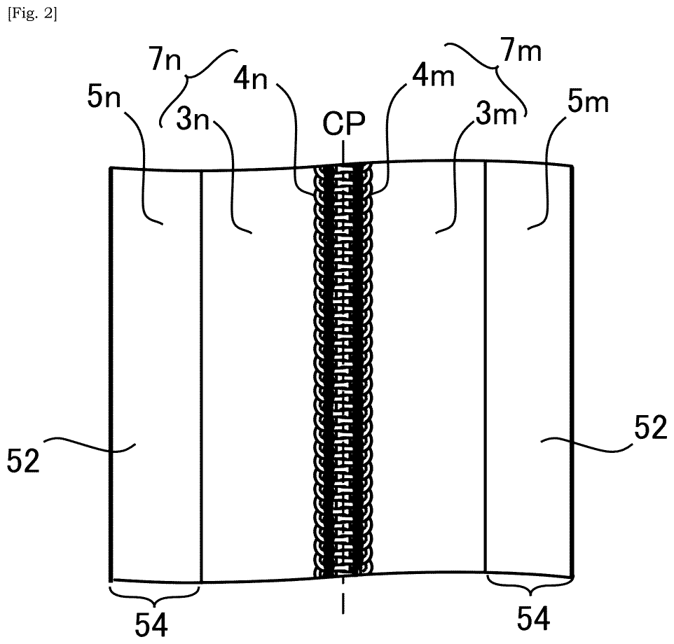

In the present description, a direction of a slider 8 moving to open and close a slide fastener 1 is set as a front-rear direction (see a double-headed arrow FB in FIG. 1). A direction matching a width direction of the slide fastener 1 and orthogonal to the front-rear direction is set as a left-right direction (see a double-headed arrow LR in FIG. 1). A direction matching a thickness direction of the slide fastener 1 and orthogonal to the front-rear direction is set as an up-down direction. The up-down direction is orthogonal to both of the front-rear and left-right directions. The up-down direction does not necessarily mean a vertical direction (gravity direction). For example, when a longitudinal direction of the slide fastener 1 is oriented in the vertical direction, the up-down direction of the slide fastener 1 is in a horizontal direction (orthogonal to the vertical direction). Thus, a direction referred to herein is unrelated to the vertical direction.

The slide fastener 1 is a flexible elongated part elongated in the front-rear direction with a constant width in the left-right direction, and includes a pair of left and right fastener stringers 2m, 2n, and a slider 8 for engaging and disengaging these fastener stringers 2m, 2n. As the slider 8 moves forward, the left-right fastener stringers 2m and 2n are engaged, forming a liquid-tight seal based on abutting condition between sealing portions 56 described below. As the slider 8 moves rearward, the left-right fastener stringers 2m and 2n are disengaged, additionally releasing the abutting condition between the sealing portions 56 described below (which results in the absence of the liquid-tight seal).

The fastener stringer 2m, 2n is a flexible elongated part elongated in the front-rear direction with a constant width in the left-right direction, and includes a water-permeable stringer 7m,7n and a covering member 5m,5n laminated onto the water-permeable stringer 7m,7n. Similarly, the water-permeable stringer 7m,7n and the covering member 5m,5n are a flexible elongated part elongated in the front-rear direction with a constant width in the left-right direction. The water-permeable stringer 7m,7n includes a water-permeable fastener tape 3m,3n and fastener element 4m,4n arranged on a side edge portion 33 of the fastener tape 3m,3n. The fastener tape 3m,3n is a flexible elongated part elongated in the front-rear direction with a constant width in the left-right direction.

The fastener tape 3m, 3n is permeable to water, allowing liquid (e.g. water) to permeate and penetrate there-through; and may be a woven fabric, a knitted fabric, or a mixed sheet of woven and knitted structures, for example. More specifically, the structure and component threads thereof (e.g. weft and warp threads) of the fastener tape may absorb liquid, resulting in the permeation and penetration of the liquid. In a form of woven fabric, the fastener tape 3m,3n includes a plurality of warp threads and at least one weft thread. Spots are formed between the adjacent warp threads in the weft direction where a thread density is sparse, and also spots are formed between adjacent portions of the weft thread in the warp direction where a thread density is sparse, possibly contributing to the permeation of liquid. In a form of knitted fabric either, spots are formed between the knitting threads where a thread density is sparse, possibly contributing to the permeation of liquid.

The fastener element 4m,4n is a coiled element sewn to the fastener tape 3m, 3n by an attachment thread 44, and may typically be sewn to the side edge portion of the fastener tape 3m, 3n so as to be placed on one main surface of the fastener tape 3m,3n. For this purpose, any sewing method such as single chain stitch sewing or double chain stitch sewing can be employed. The coiled element consists of a helically wound monofilament and has a gap between portions of the monofilament, and thus has water permeability. Specifically, in the coiled element, element units U1, which are each equivalent to one turn of the helically wound monofilament, are continuously formed in the front-rear direction (see FIG. 3). Each element unit U1 includes a head 41 extending in the up-down direction, a pair of legs 42 connected to the upper and lower ends of the head 41 respectively, and a connecting portion 43 connecting the legs 42 between adjacent element units U1. The head 41 is molded to be wider than the leg 42 in the front-rear direction at an appropriate degree, and thus the heads 41 of the left and right fastener elements 4m, 4n can be engaged with each other and disengaged from each other. Different types of fastener element may also be employed. A core thread may be introduced into a hollow of the helical monofilament of the coiled element, but may be omitted.

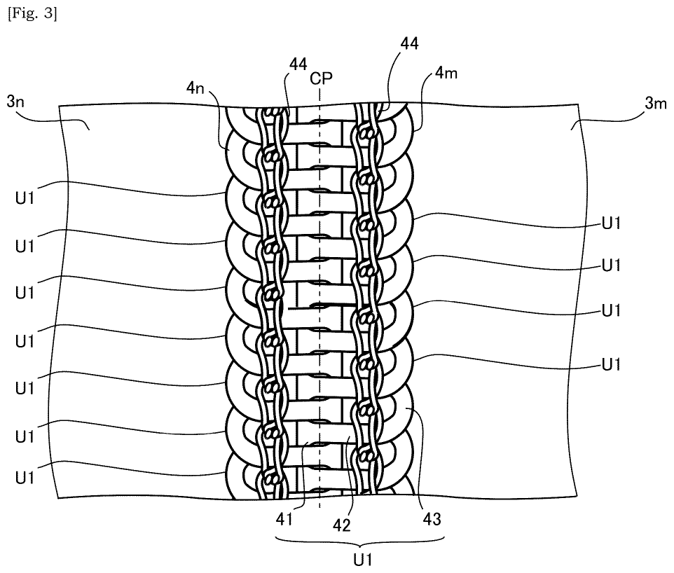

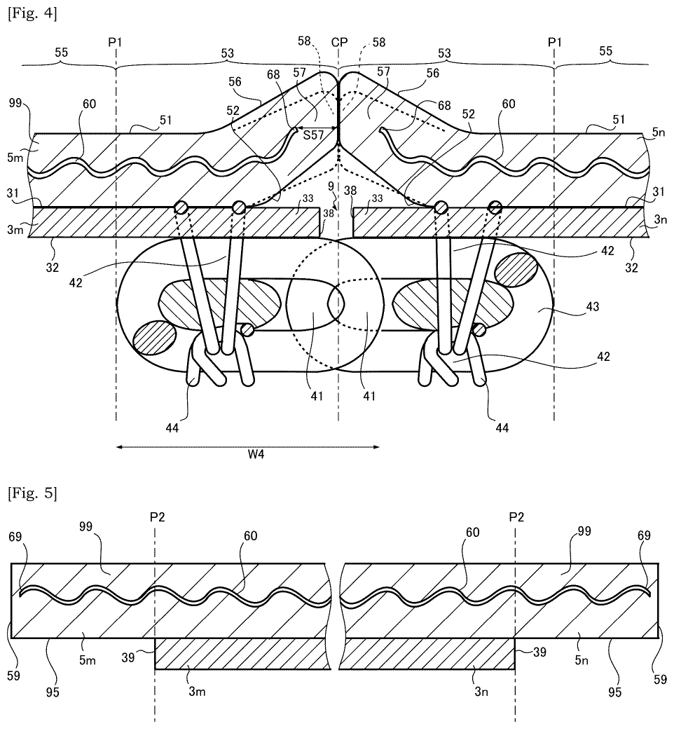

In some cases including the illustrated examples, the covering member 5m,5n is wider than the fastener tape 3m,3n, and can be sectioned into an inner portion 53, an attachment portion 54, and an intermediate portion 55 in the width direction. The intermediate portion 55 is continuous with the inner portion 53, and the attachment portion 54 is continuous with the intermediate portion 55. The respective inner portions 53 of the left and right covering members 5m,5n include sealing portions 56 which are brought into abutting condition with each other when the left and right fastener elements 4m, 4n are engaged. The inner portion 53 may be partially laminated onto one main surface of the fastener tape 3m,3n. The intermediate portion 55 may be laminated, in its entirety, onto the one main surface of the fastener tape 3m,3n. As illustrated in FIG. 4, a boundary between the inner portion 53 and the intermediate portion 55 of the covering member 5m,5n may be defined in a plane P1 which is in contact with the connecting portion 43 of the fastener element 4m,4n, and orthogonal to the width direction of the slide fastener 1. As illustrated in FIG. 5, a boundary between the intermediate portion 55 and the attachment portion 54 of the covering member 5m, 5n may be defined in a plane P2 which is in contact with an outer edge face 39 of the fastener tape 3m,3n and orthogonal to the width direction of the slide fastener 1.

The attachment portion 54 of the covering member 5m,5n is not laminated onto the fastener tape 3m,3n, and thus has an exposed surface 95 without being covered by the fastener tape 3m,3n. The attachment portion 54 is positioned farther from the sealing portion 56 than the fastener tape 3m, 3n in the width direction of the fastener stringer 2m, 2n. One or both surfaces of the attachment portion 54 may be used for attachment of the fastener stringer 2m, 2n onto an open section of an article such as clothes, bag, or tent (e.g. by a method such as thermocompression bonding or the like).

The slide fastener 1 may have a center plane CP in a state where the fastener elements 4m,4n are engaged. The center plane CP is a plane orthogonal to the width direction of the slide fastener 1. Moreover, the center plane CP is set at the center of engaging heads 41 of the fastener elements 4m,4n in the width direction of the slide fastener 1. The above-noted planes P1 and P2 each is a plane parallel to the center plane CP.

The covering member 5m, 5n (directly) covers the fastener tape 3m, 3n (i.e. is laminated directly onto the fastener tape 3m,3n) so as to prevent a liquid from permeating and penetrating through the fastener tape 3m,3n, and has a sealing portion 56 at an opposite position of (e.g. at a position above) the fastener element 4m,4n with respect to the fastener tape 3m,3n in the thickness direction of the fastener tape 3m, 3n (see FIG. 4). For example, in a case where the fastener element 4m, 4n is positioned below the fastener tape 3m, 3n, the sealing portion 56 is positioned above the fastener tape 3m,3n. The sealing portion is preferably overlaid by the fastener element in a plan view. In other words, as illustrated in FIG. 4, the sealing portion is located inwardly (on the side of the inner edge face 38) from the plane P1 which is in contact with the connecting portion 43 of the fastener element 4m,4n and orthogonal to the width direction of the slide fastener 1.

The covering members 5m, 5n each is formed of a soft material 99 and in more detail, is formed of a soft material 99 (e.g. rubber, elastomer, resin (e.g. polyurethane), or mixture thereof) that does not permit permeation and penetration of liquid. Due to the waterproof property of the covering member 5m,5n, the waterproof property of the fastener stringer 2m, 2n is ensured (i.e. the fastener stringer 2m, 2n functions as a waterproof stringer, and the slide fastener 1 functions as a waterproof fastener) regardless of the water permeability of the water-permeable stringer 7m,7n. The soft material 99 may include one or more additives, in addition to a main material such as rubber, elastomer, or resin, in order to enhance or improve the physical property or chemical property. The soft material 99 may also include a pigment (an inorganic pigment or an organic pigment) in addition to the above-described main material so that the cover may have a desired color in accordance with the pigment.

The waterproof performance (level of waterproofness) of the slide fastener 1 depends on various internal parameters such as material, thickness, and density of components of the fastener stringer 2m, 2n, and also depends on external parameters such as water pressure applied to the slide fastener 1. The slide fastener 1 may be designed to have intermediate waterproof performance between the less expensive slide fasteners with limited water repellency and the expensive slide fasteners with sufficient capability of water-tightness or airtightness described at the beginning; however it should not be limited to this level of waterproofness and may have a lower or higher waterproof level than that level.

In the present embodiment, the covering member 5m, 5n is configured as a supporting substrate that supports the fastener tape 3m, 3n (see FIGS. 4 and 5). That is, the covering member 5m, 5n is not supported by the fastener tape 3m,3n, but the fastener tape 3m, 3n is supported by the covering member 5m,5n. For this purpose, the covering member 5m, 5n has lower flexibility than the fastener tape 3m, 3n. The covering member 5m, 5n may be formed to be thicker than the fastener tape 3m,3n. The covering member 5m, 5n may be formed to have a thickness equal to or greater than a predetermined thickness so as to have desired sealing performance.

In the present embodiment, the covering member 5m, 5n includes a flexible core sheet 60 that extends in the longitudinal direction of the fastener stringer 2m, 2ne. Furthermore, the core sheet 60 is embedded in the soft material 99 such that one surface of the core sheet 60 is at least partially exposed or both surfaces of the core sheet 60 are not exposed. According to such a configuration, the soft material 99 is supported by the core sheet 60, and the shape of the covering member 5m, 5n including the sealing portion 56 is stabilized. This allows the use of inexpensive fastener tapes which can be mass-produced as the fastener tape 3m,3n, and facilitating cost reduction of the slide fastener 1. Note that the core sheet 60 extends in the longitudinal direction of the slide fastener 1 (similarly, fastener stringer 2m, 2n) in order to support the fastener tape 3m,3n. The layer of the soft material 99 is adhered to and supported by one surface or both surfaces of the core sheet 60 (see FIG. 4). In a case where one surface of the core sheet 60 is exposed, the other surface of the core sheet 60 on the opposite side of the exposed surface is not exposed.

In a case where the soft material 99 is adhered to just one surface of the core sheet 60, the core sheet 60 is exposed from the soft material 99 on the other surface on the opposite side thereof. In a case where the soft material 99 is adhered to both surfaces of the core sheet 60, both surfaces of the core sheet 60 are covered by the soft material 99 and are not exposed. Whether a surface of the core sheet 60 is exposed or not depends on whether a single piece of the covering member 5m, 5n can be seen from the outside. The soft material 99 has a two-dimensional spread, and can be observed as a layer or a sheet in a cross-section of the covering member 5m, 5n in the both directions of the width and longitudinal directions of the slide fastener 1.

The fastener tape 3m,3n may be a kind of fastener tape in which a fastener element is not woven into (e.g. a fastener tape with a coil element sewn thereto). As described above, it is the covering member 5m,5n acting as a supporting substrate, not the fastener tape 3m,3n. Thus, it is allowed to use inexpensive fastener tapes (similarly, the water-permeable stringer 7m,7n) which can be mass-produced for the fastener tape 3m,3n, and facilitating cost reduction of the slide fastener 1. It can be said that the high flexibility of the inexpensive fastener tape 3m, 3n is counterbalanced or compensated by the low flexibility of the covering member 5m,5n.

Note that, in a kind of fastener tape in which a fastener element (in particular, a coil-like element including a helically wound monofilament) is woven into the fastener tape, the fastener element is incorporated into the tape woven structure through interlacing with the weft thread of the fastener tape. In this case, the flexibility of the fastener tape is reduced, and the fastener tape may be used as a supporting substrate for a soft material such as polyurethane coating, but the cost tends to be higher.

The fastener tape 3m, 3n has a tape top surface 31 and a tape bottom surface 32, and has a thickness defined by these surfaces (see FIG. 4). The tape top surface 31 and the tape bottom surface 32 are main surfaces that define the thickness of the fastener tape 3m, 3n. The thickness direction of the fastener tape 3m, 3n is the direction orthogonal to the tape top surface 31 and the tape bottom surface 32. The fastener element 4m,4n is sewn to the tape bottom surface 32 of the fastener tape 3m,3n. The covering member 5m, 5n has a top surface 51 and a bottom surface 52, and has a thickness defined by these surfaces. The covering member 5m, 5n is laminated onto the tape top surface 31 of the fastener tape 3m,3n, and is typically laminated via an adhesive or an adhesive layer. Peeling of the covering member 5m, 5n off the fastener tape 3m, 3n requires a strong force, and forcible peeling may break one or both of the covering member 5m,5n and the fastener tape 3m,3n. Advantageously, the stitches of the attachment thread 44 are covered by the covering member 5m, 5n on the tape top surface 31 of the fastener tape 3m,3n, and accordingly, the position of the fastener element 4m,4n is stabilized on the side of the tape bottom surface 32 of the fastener tape 3m,3n. As a result, abutting of the pair of sealing portions 56 as the fastener elements 4m,4n are engaged is strengthened and the waterproof property of the slide fastener 1 is enhanced.

In the width direction of the slide fastener 1 (similarly, fastener stringer 2m, 2n), the fastener tape 3m, 3n has the inner edge face 38 (see FIG. 4) and the outer edge face 39 (see FIG. 5). When the left and right fastener elements 4m, 4n are engaged, the inner edge faces 38 of the left and right fastener tapes 3m, 3n are arranged to face each other, and a gap 9 is formed between the inner edge faces 38. The sealing portions 56 are brought into abutting condition with each other at a position over the gap 9 in planar view (i.e. at an upper position over the gap 9) so as to form a liquid-tight seal that prevents permeation and penetration of liquid through the gap 9 otherwise caused when the liquid-tight seal is not formed.

In the width direction of the slide fastener 1 (similarly, fastener stringer 2m, 2n), the covering member 5m, 5n has a sealing face 58, as an inner edge face (see FIG. 4), and an outer edge face 59 (see FIG. 5). Similarly, the core sheet 60 has an inner edge 68 (see FIG. 4) and an outer edge 69 (see FIG. 5). The sealing face 58 of the cover 5m is positioned outwardly of the fastener tape 3m than the inner edge face 38 of the fastener tape 3m. Similarly, the sealing face 58 of the cover 5n is positioned outwardly of the fastener tape 3n than the inner edge face 38 of the fastener tape 3n. The outer edge face 59 of the cover 5m is positioned outwardly of the fastener tape 3m than the outer edge face 39 of the fastener tape 3m. Similarly, the outer edge face 59 of the cover 5n is positioned outwardly of the fastener tape 3n than the outer edge face 39 of the fastener tape 3n. This allows easier welding/bonding of the slide fastener 1 to a target fabric. The phrase “outwardly of fastener tape” indicates a direction being directed from a position on a main surface of a fastener tape to a position outside the main surface and crossing a side edge of the fastener tape extending in the longitudinal direction. The inner edge can be referred to as one edge, and the outer edge can be referred to as the other edge. The inner edge face can be referred to as one edge face, and the outer edge face can be referred to as the other edge face.

In some cases, the inner edge 68 of the core sheet 60 is embedded in the sealing portion 56, thereby allowing the sealing portion 56 to have increased hardness and enhanced sealing performance. Preferably, the inner edge 68 of the core sheet 60 is positioned away from the sealing face 58 of the sealing portion 56 within an extent above the fastener element 4m,4n (within a width W4 of the fastener element 4m,4n), thereby forming a soft portion 57 between the inner edge 68 of the core sheet 60 and the sealing face 58 and allowing the sealing portion 56 to have moderate softness. This may allow reduction of force required to move the slider 8 so as to engage the fastener elements 4m, 4n and so as to bring the sealing portions 56 into abutting condition against each other. In a case where the core sheet 60 is a woven fabric, a knitted fabric or a paper, fiber(s) may be mixed into the soft material 99 (e.g. the layer portion thereof, the sealing portion 56 and/or the soft portion 57).

A distance S57 (see FIG. 4) between the inner edge 68 of the core sheet 60 and the sealing face 58 in the width direction of the slide fastener 1 (similarly, covering member 5m, 5n) may be ½ or less or ⅓ or less of the lateral width W4 (see FIG. 4) of the fastener element 4m, 4n in the same direction. This may facilitate the above-described effect. In a typical example, the distance between the inner edge 68 of the core sheet 60 and the sealing face 58 in the width direction of the slide fastener 1 (similarly, covering member 5m,5n) is 1 cm or less, 5 mm or less, 3 mm or less, or 2 mm or less.

A woven sheet, a knitted sheet, a mixed sheet of woven and knitted structures, a paper sheet, a nonwoven fabric, or a metal foil may be used for the core sheet 60. Each of the woven sheet, the knitted sheet, the woven and knitted sheet, the paper sheet, the nonwoven fabric, and the metal foil has flexibility. The woven sheet, the knitted sheet, the mixed sheet of woven and knitted structures, the paper sheet, the nonwoven fabric, or the metal foil may be advantageously wider than the fastener tape 3m, 3n of the water-permeable stringer 7m,7n. This allows the soft material 99 to be supported at an adequate extent or degree.

In a situation where the woven sheet, the knitted sheet or the mixed sheet of woven and knitted structures is used as the core sheet 60, the covering member 5m,5n would have a pattern corresponding to the woven structure and/or the knitted structure of the core sheet 60, allowing the slide fastener 1 to have an appearance similar to those of common slide fasteners. For example, in a case where the woven sheet includes twill weave, the covering member 5m,5n would have a pattern in which diagonal lines (diagonal wales) are arranged sequentially along the longitudinal direction. A fastener tape having the same structure as the fastener tape 3m, 3n of the water-permeable stringer 7m,7n may be used as a woven sheet of the core sheet 60, thus facilitating reduction of the material cost.

The sealing portion 56 may be displaceable away from and closer to the tape top surface 31 of the fastener tape 3m, 3n along the up-down direction (see FIG. 4). Specifically, the inner portion 53 is partially not adhered to the side edge portion 33 of the fastener tape 3m, 3n on the side opposite to the fastener element 4m,4n and as a result, forming the sealing portion 56 which is displaceable along the up-down direction as noted above, facilitating reduction of force required for movement of the slider 8. Note that as the left and right fastener elements 4m,4n are engaged, the sealing portions 56 of the left and right covering members 5m, 5n abut against each other to form a watertight seal. In the process of engagement of the fastener elements 4m,4n, the sealing portions 56 push each other and as a result, each sealing portion 56 may be displaced away from the fastener element 4m, 4n upward from the position indicated by the dotted line to the position indicated by the solid line in FIG. 4.

The sealing portion 56 may be molded into various shapes. As illustrated in FIG. 4, the sealing portion 56 may be shaped as a slanting portion that is obliquely angled or can be shaped to include such slanting portion. The sealing portion 56 extends outwardly of fastener tape so as to be upwardly away from the tape top surface 31 of the fastener tape 3m, 3n gradually. Similarly, a portion of the core sheet 60 included in the sealing portion 56 extends outwardly of fastener tape so as to be upwardly away from the tape top surface 31 of the fastener tape 3m,3n gradually. It should be noted that, as the internal space of the slider 8 is restricted, the left and right sealing portions 56 may be brought into contact with the fastener tapes 3m,3n at least partially, respectively (see FIG. 6).

The slider 8 is designed for engagement and disengagement of the fastener stringers 2m, 2n. Typically, as shown in FIG. 6, the slider 8 has an upper blade 81, a lower blade 82, and a connecting column (not shown) extending in the up-down direction to connect the upper blade 81 and the lower blade 82, thus defining a Y-shaped element passage. It would be possible to provide flange walls 83 that upwardly stand on the left and right side edge portions of the lower blade 82 so that displacement of the left and right fastener elements 4m,4n is restricted in the width direction of the slider 8.

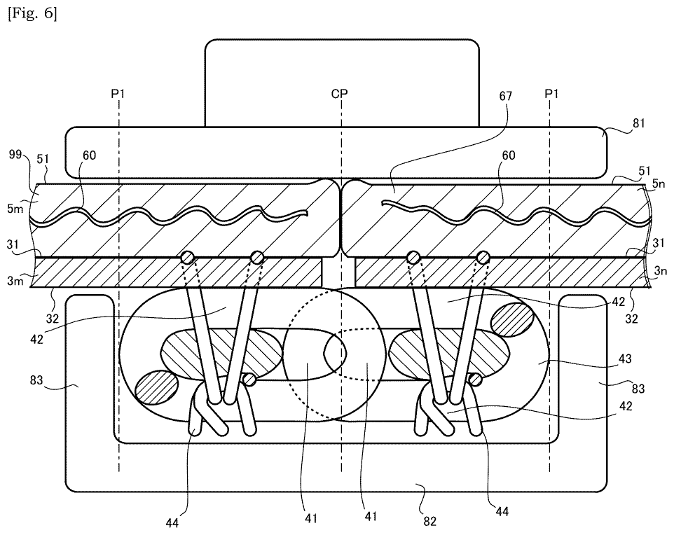

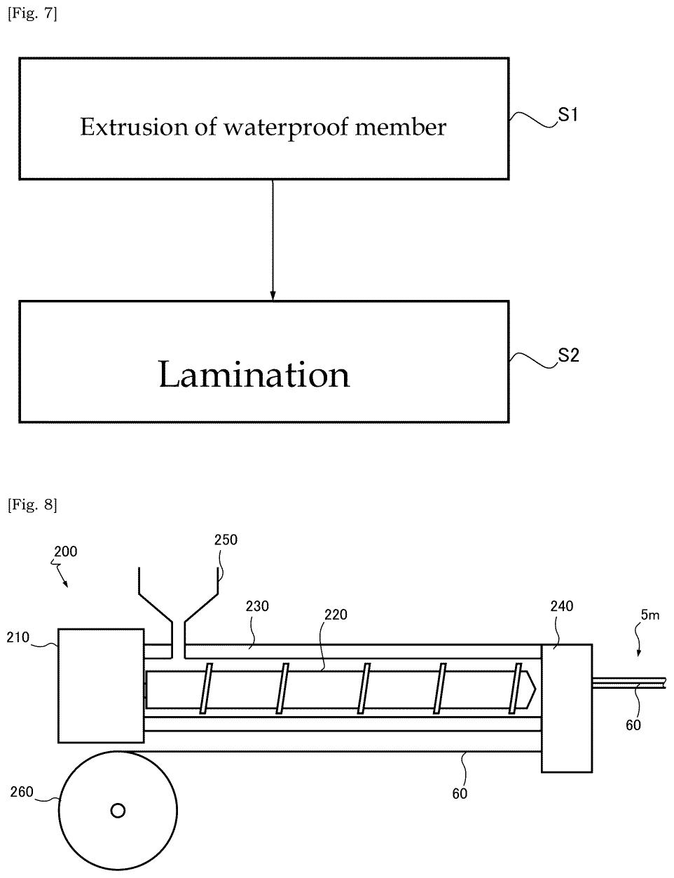

The fastener stringer 2m, 2n may be manufactured through the procedure illustrated in FIG. 7. The fastener stringers 2m, 2n are engaged so that a waterproof chain is produced. A slider is engaged with engaged fastener elements of the waterproof chain so that a slide fastener is produced. Known techniques and facilities in the field of slide fasteners may be used for cutting the waterproof chain and for attaching a slider, and thus detailed descriptions thereof is omitted.

As illustrated in FIG. 7, the method of manufacturing the fastener stringer 2m, 2n may include: a process (S1) of forming a covering member 5m, 5n through extrusion molding; and a process (S2) of laminating the covering member 5m,5n onto the fastener tape 3m,3n so as to support the fastener tape 3m,3n by the covering member 5m, 5n, the fastener tape 3m, 3n having the side edge portion on which the fastener element is arranged. The method of manufacturing the fastener stringer 2m, 2n may further include a process of manufacturing a water-permeable stringer 7m,7n in which the fastener element 4m,4n is arranged on the side edge portion 33 of the fastener tape 3m, 3n. The fastener element 4m,4n may be a coiled element sewn to the fastener tape 3m,3n by an attachment thread 44.

In the extrusion molding, an exemplary extruder 200 illustrated in FIG. 8 may be used, and operation of the extruder 200 enables continuous production of the covering member 5m, 5n at lower cost. The extruder 200 includes a rotating machine 210, a screw 220 rotated by the rotating machine 210, a cylinder 230 accommodating the screw 220, a die 240, an inlet 250 for soft material, and a reel 260 around which a core sheet 60 is wound. As the screw 220 rotates, the soft material is fed toward the die 240, passes through an aperture of the die 240 and is discharged as a molded portion shaped corresponding to the aperture contour in cross section. The core sheet 60 is also fed to the die 240 in synchronization with the soft material. The core sheet 60 serves as a supporting substrate that supports the soft material, and suppresses flow of the soft material at the time of passing through the aperture of the die 240. As a result, the extrusion-molded part extruded from the extruder 200 (fastener stringer 2m, 2n) would have a stabilized shape. The extruder 200 may take various configurations other than those shown in the drawings.

Stable production of the extrusion-molded part (i.e. the covering member 5m,5n including the sealing portion 56) may not be easier in a case where a soft material (e.g. polyurethane) is used without the core sheet which is suitable for ensuring adequate softness of the sealing portion 56. In the present disclosure, the core sheet 60 is introduced into the soft material during the extrusion molding, and the soft material is adhered to and supported by one surface or both surfaces of the core sheet 60, resulting in stabilized shape of the extrusion-molded part (i.e. the covering member 5m,5n including the sealing portion 56). Note that the core sheet 60 may be embedded in the soft material such that one surface of the core sheet 60 is at least partially exposed or both surfaces of the core sheet 60 are not exposed.

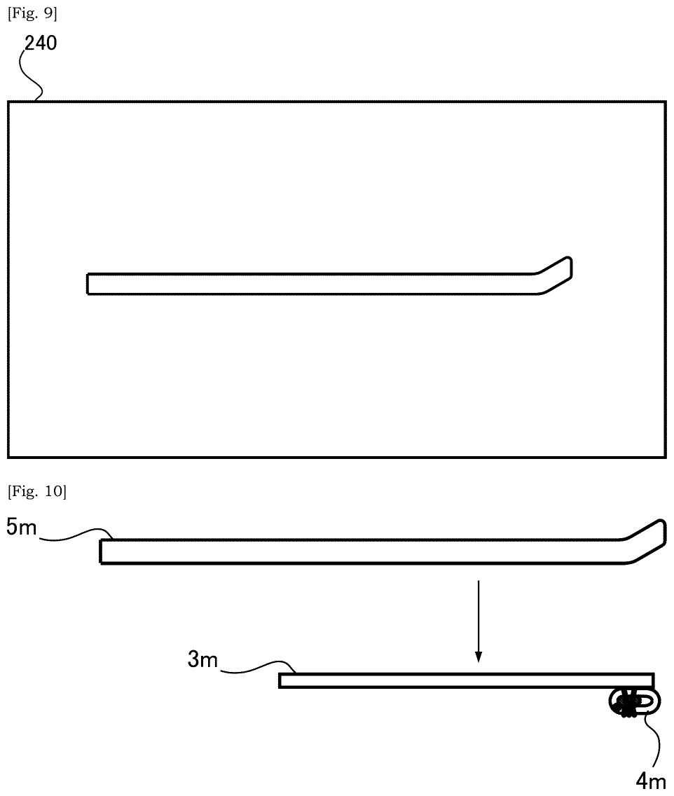

The covering member 5m, 5n may be molded from the soft material and the core sheet so as to have a desired intended cross-sectional shape based on designing of the aperture shape of the die 240. The aperture shape of the die 240 is designed such that the outline of the cross-sectional shape of the covering member 5m,5n which is orthogonal to the longitudinal direction thereof is defined. The die 240 illustrated in FIG. 9 is used for producing the covering member 5m,5n illustrated in FIG. 4. A die having another aperture shape may also be used.

Setting may be established such that the core sheet 60 travels at a predetermined position within the aperture of the die 240. In some cases, the travel path of the core sheet 60 may be set such that one end of the core sheet 60 (the inner edge 68 described above) in the lateral direction orthogonal to the extrusion direction of the extrusion-molded part (fastener stringer 2m, 2n) is embedded in the sealing portion 56. It is also possible to set the travel path of the core sheet 60 such that one end of the core sheet 60 (the inner edge 68 described above) is positioned away from the sealing face 58 of the sealing portion 56 so as to form the soft portion 57 between the one end of the core sheet 60 (the inner edge 68 described above) and the sealing face 58, achieving similar effect to the above-noted one.

In the process of laminating, the covering member 5m, 5n may be laminated onto the fastener tape 3m,3n so as to have the sealing portion 56 on the opposite position of the fastener element 4m,4n. In addition, the covering member 5m,5n may be laminated onto the fastener tape 3m,3n such that the sealing portion 56 is displaceable away from and closer to the fastener tape 3m,3n. The adhesive or the adhesive layer used for laminating the covering member 5m,5n onto the fastener tape 3m,3n may preferably include a water-resistant adhesive material. Thermocompression bonding may also be available between the covering member 5m,5n and the fastener tape 3m,3n without using the adhesive material.

Extrusion of the covering member 5m, 5n from the extruder 200 and lamination of the covering member 5m, 5n onto the fastener tape 3m, 3n may be successively performed without cutting the covering member 5m, 5n at a position between the extruder 200 and a location where the lamination is performed. The soft material 99 is adequately soft as not completely cured in the covering member 5m, 5n being continuously extruded from the extruder 200, and therefore the soft material 99 itself may be used for a purpose of the lamination onto the fastener tape 3m,3n (i.e. as an adhesive). In this case, the step S1 and the step S2 are performed continuously in the same period. Of course, the step S1 and the step S2 may be performed discontinuously in different periods. For example, the covering member 5m, 5n continuously extruded from the extruder 200 may be cut, wound around a reel or the like, and stored. On another day and/or at another place, the covering member 5m,5n produced and stored in advance as described above may be laminated onto the fastener tape 3m,3n.

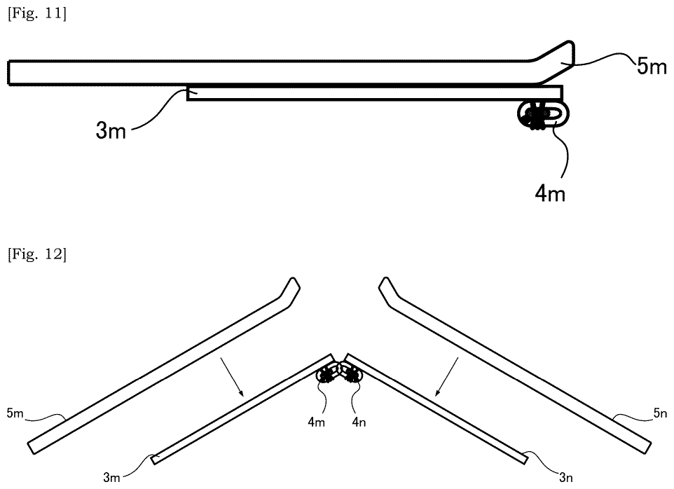

In FIG. 10, an adhesive is applied to or an adhesive layer is formed onto at least one of the bottom surface of the cover 5m and the top surface of the fastener tape 3m. As illustrated in FIG. 11, the cover 5m and the fastener tape 3m are stacked via the adhesive or the adhesive layer interposed therebetween so that they are laminated in intimate contact each other. The sealing portion of the cover may be appropriately positioned relative to the fastener element by performing the lamination of the cover and the fastener tape for each one fastener stringer as illustrated in FIGS. 10 and 11. As illustrated in FIG. 12, it is also possible to laminate the covering members 5m, 5n onto the fastener tapes 3m,3n of the fastener chain respectively in which the left and right water-permeable stringers have been engaged with each other. Of course, the lamination of the covers onto the fastener tapes of the fastener chain inevitably requires and encompasses the lamination of the covers onto the fastener tapes of the water-permeable stringers.

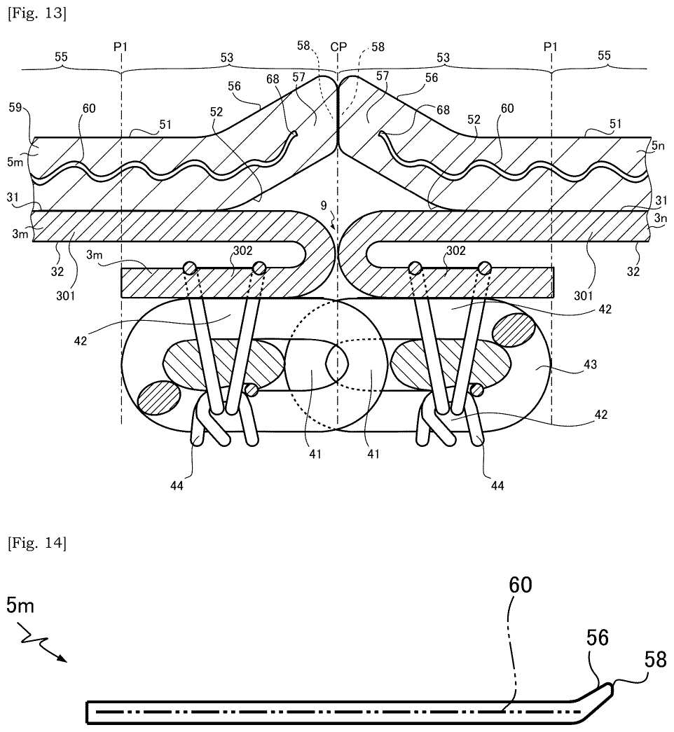

Various modifications may be made to the water-permeable stringer 7m,7n onto which the covering member 5m,5n is laminated. In FIG. 13, the fastener tape 3m,3n has a folded portion 302 folded relative to the tape main portion 301, and the fastener element 4m, 4n is sewn to the folded portion 302. Similar effect to those described above may be achieved as long as the above-described characteristics are satisfied even when such water-permeable stringers 7m,7n differently configured are employed.

Various modifications may be made to the shape of the covering member 5m,5n. In terms of shaping the sealing portion 56 into the slanting portion, the sealing portion 56 along the longitudinal direction of the fastener stringer 2m, 2n may be shaped to be tapered in the cross section as illustrated in FIG. 14. Accordingly, the sealing face 58 of the sealing portion 56 would have a narrower width in the up-down direction, thereby reducing a force required to move the slider 8 so as to engage the fastener elements 4m, 4n and to bring the sealing portions 56 to abut against each other. Although not clearly illustrated in FIG. 14, the inner edge 68 of the core sheet 60 is embedded in the sealing portion 56.

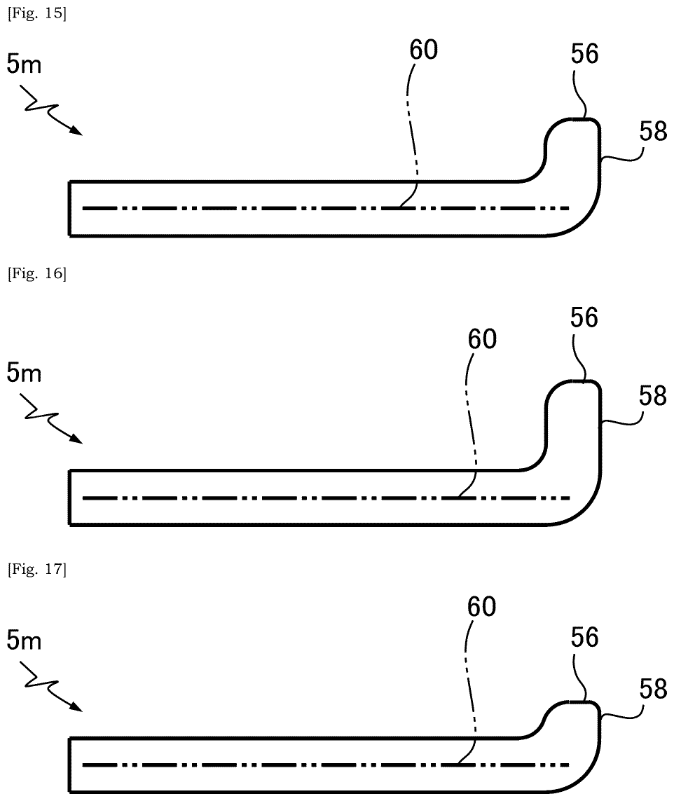

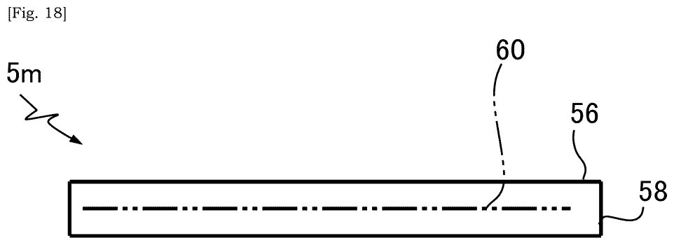

Also, the sealing portion 56 may be shaped into or shaped to include a wall that stands upright along the longitudinal direction of the fastener stringer 2m, 2n in the cross section as illustrated in FIG. 15. The wall has a pair of wall surfaces extending in the longitudinal direction of the fastener stringer 2m, 2n and defining the width of the wall, and one of the wall surfaces functions as the sealing face 58. As can be seen from FIGS. 16 and 17, the height of the wall is adjustable. As illustrated in FIG. 18, the covering member 5m,5n may be molded as a flat sheet. Even in such a case, it would be possible to let the covering member 5m, 5n have the sealing portion 56, by laminating the covering member 5m,5n onto the water-permeable stringer 7m,7n in an appropriate relative position.

Based on the above teachings, those skilled in the art may make various changes to each embodiment and each feature. The covering members 5m, 5n may be produced through different methods. The codes incorporated in the claims are for reference only and should not be referred to for a purpose of limiting the scope of claims.

### REFERENCE CODE

1: Slide fastener
2m: Fastener stringer
2n: Fastener stringer
3m: Fastener tape
3n: Fastener tape
4m: Fastener element
4n: Fastener element
5m: Covering member
5n: Covering member
7m: Water-permeable stringer
7n: Water-permeable stringer
56: Sealing portion
57: Soft portion
58: Sealing face
60: Core sheet
99: Soft material

1. A fastener stringer comprising:
a fastener tape;
a fastener element arranged on a side edge portion of the fastener tape; and
a covering member made of soft material and covering the fastener tape, the covering member comprising a sealing portion positioned on an opposite side of the fastener element with respect to the fastener tape in a thickness direction of the fastener tape, wherein
the covering member includes a flexible core sheet extending in a longitudinal direction of the fastener stringer, and the core sheet is embedded in the soft material such that one surface of the core sheet is at least partially exposed or both surfaces of the core sheet are not exposed.

2. The fastener stringer according to claim 1, wherein the covering member is configured as a supporting substrate that supports the fastener tape

3. The fastener stringer according to claim 1, wherein one end of the core sheet in a width direction of the fastener stringer is embedded in the sealing portion.

4. The fastener stringer according to claim 1, wherein one end of the core sheet in a width direction of the fastener stringer is positioned away from a sealing face of the sealing portion within an extent above the fastener element, and a soft portion is formed between the one end of the core sheet and the sealing face in the width direction of the covering member.

5. The fastener stringer according to claim 4, wherein a distance between the one end of the core sheet and the sealing face in the width direction of the covering member is 1 cm or less.

6. The fastener stringer according to claim 1, wherein the core sheet is a woven sheet, a knitted sheet, a mixed sheet of woven and knitted structures, a paper sheet, a nonwoven fabric or a metal foil.

7. The fastener stringer according to claim 1, wherein the sealing portion is displaceable away from and closer to the fastener tape.

8. The fastener stringer according to claim 1, wherein the covering member is wider than the fastener tape.

9. The fastener stringer according to claim 8, wherein the covering member includes an attachment portion, the attachment portion being positioned farther from the sealing portion than the fastener tape in a width direction of the fastener stringer and having an exposed surface exposed as not being covered by the fastener tape.

10. The fastener stringer according to claim 1, wherein the sealing portion is shaped to include a slanting portion that is obliquely angled or a wall that stands upright.

11. The fastener stringer according to claim 1, wherein the fastener element is a coiled element sewn to the fastener tape by an attachment thread.

12. The fastener stringer according to claim 11, wherein the fastener tape has a main surface at least partially covered by the covering member, and stitches of the attachment thread are covered by the covering member on the main surface.

13. A method of manufacturing a fastener stringer, the method comprising:
performing extrusion molding to form a covering member in which a flexible core sheet is embedded in soft material such that one surface of the core sheet is at least partially exposed or both surfaces of the core sheet are not exposed; and
laminating the covering member onto a fastener tape so as to support the fastener tape by the covering member, the fastener tape having a side edge portion on which a fastener element is arranged.

14. The method of manufacturing a fastener stringer according to claim 13, wherein the covering member is laminated onto the fastener tape so as to have a sealing portion positioned on an opposite side of the fastener element with respect to the fastener tape.

15. The method of manufacturing a fastener stringer according to claim 13, wherein the covering member is laminated onto the fastener tape such that the sealing portion is displaceable away from and closer to the fastener tape.

16. The method of manufacturing a fastener stringer according to claim 13, wherein extrusion of the covering member by an extruder and lamination of the covering member onto the fastener tape are successively performed without cutting the covering member at a position between the extruder and a location where the lamination is performed.
